(19) United States
(12) Patent Application Publication
(10) Pub. No.: US 2019/0245755 A1
(43) Pub. Date: Aug. 8, 2019

(54) NETWORK TESTING

(71) Applicant: Sony Corporation, Minato-ku (JP)

(72) Inventor: Richard Cooper, Basingstoke (GB)

(73) Assignee: Sony Corporation, Minato-ku (JP)

(21) Appl. No.: 16/243,233

(22) Filed: Jan. 9, 2019

(30) Foreign Application Priority Data
Feb. 2, 2018 (GB) 1801767.3

(51) Int. Cl. H04L 12/24; H04L 12/721

(52) U.S. Cl. CPC H04L 41/145; H04L 45/14

(57) ABSTRACT

Network testing apparatus comprises software defined network controller circuitry; and test controller circuitry operable to configure a test network in response to network definition data, to provide instructions to control operations of the software defined network controller circuitry and to control operations of a plurality of test traffic agents connected to the test network; the software defined network controller circuitry being arranged to control the test network to adopt a routing arrangement for data packets within the test network in response to an instruction provided by the test controller circuitry; and the test controller circuitry being configured to perform a network test by instructing the software defined network controller circuitry to control the test network to adopt one or more test routing arrangements, instructing the test traffic agents to communicate test data packets to respective destinations amongst the test traffic agents using the test network and detecting whether the test packets correctly arrive at their respective destinations under a current test routing arrangement as adopted by the test network.

### BACKGROUND

### Field

This disclosure relates to network testing.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, is neither expressly or impliedly admitted as prior art against the present disclosure.

In a traditional packet-based network, a so-called control plane and a so-called data plane both exist directly on each network device. However, in so-called Software Defined Networking, there is an abstraction of the control plane from the network device. The control plane exists in a separate SDN controller layer. It can interact with the data plane of a network device (such as a switch or router) for example via a controller agent on the network device (using a protocol such as “OpenFlow”).

Software defined networking allows more flexible network architectures, potentially with centralised control. The SDN controller is able to oversee the whole network and thus can potentially provide better forwarding policies than would be the case in the traditional network.

However, there is a need to provide appropriate arrangements to test the correct operation of such a network.

### SUMMARY

The present disclosure addresses or mitigates problems arising from this processing.

Respective aspects and features of the present disclosure are defined in the appended claims.

It is to be understood that both the foregoing general description and the following detailed description are exemplary, but are not restrictive, of the present technology.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, in which:

FIG. 1 schematically illustrates a so-called traditional network;

FIG. 2 schematically illustrates a so-called software defined network;

FIG. 3 schematically illustrates an example network;

FIG. 4 schematically illustrates a timed switching operation;

FIGS. 5 to 7 are schematic timing diagrams illustrating example switching operations;

FIG. 8 schematically illustrates a test arrangement;

FIGS. 9 to 11 are schematic timing diagrams illustrating aspects of the operation of the arrangement of FIG. 8;

FIG. 12 schematically illustrates a data processing apparatus; and

FIG. 13 is a schematic flowchart illustrating a method.

### DESCRIPTION OF THE PREFERRED EMBODIMENTS

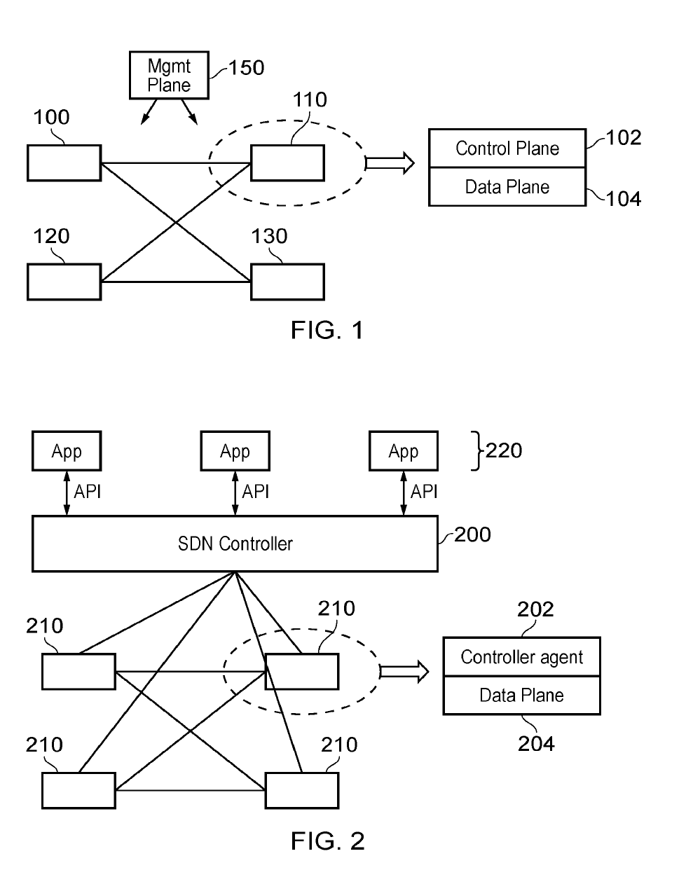

Referring now to the drawings, FIG. 1 schematically illustrates a previously proposed network packet routing arrangement in which (in this example) four network switches or routers 100 . . . 130 are interconnected by data connections 140.

This type of network device, for example switches and routers, are traditionally thought of as consisting of three planes: the management plane (implemented in FIG. 1 by a separate device 150), the control plane 102 and the data plane 104.

In the arrangement of FIG. 1, the management plane is used to manage the network device through its network connection. It typically uses protocols such as Simple Network Management Protocol (SNMP), Telnet, File Transfer Protocol (FTP), Secure FTP or Secure Shell (SSH) to allow the user to monitor the device or send commands to it using a command-line interface (CLI).

The control plane 102 handles decisions such as packet forwarding and routing. On previously proposed network devices such as those of FIG. 1, this can be done with static routes or dynamic routing protocols (such as OSPF—Open Shortest Path First). The control plane provides the information used to build the forwarding table that is used by the data plane.

The data plane uses the forwarding table created by the control plane to process the network data packets. It is sometimes known as the forwarding plane or user plane. Data plane forwarding is processed in dedicated hardware or high-speed code. The data plane is where most of the network device's activity occurs.

### Software Defined Networking (SDN)

In a traditional network (non-SDN), the control plane and data plane both exist directly on the network device as shown schematically in FIG. 1. However, in so-called Software Defined Networking, there is an abstraction of the control plane from the network device. The control plane exists in a separate SDN controller layer 200. It interacts with the data plane 204 of a network device 210 (such as a switch or router) via a controller agent 202 on the network device 210 (using a protocol such as “OpenFlow”). The SDN controller 200 controls the network to adopt a routing arrangement for data packets by providing control signals and/or instructions to the network devices, for example by a so-called “Southbound API” (discussed below).

Software defined networking allows more flexible network architectures, potentially with centralised control. The SDN controller 200 is able to oversee the whole network and thus potentially to provide better forwarding policies than would be the case in the arrangement of FIG. 1.

Considering the interfaces with the SDN controller 200 in FIG. 2, these are sometimes referred to by a schematic notation relating to the direction in which they are drawn on a typical representation such as that of FIG. 2.

### Southbound API

The so-called Southbound API (application programming interface) refers to the interface between the SDN controller and the network device. It has this name because it is typically drawn in a diagrammatic representation (which may or may not be entirely different to a physical arrangement or layout) as running generally downwards with respect to the SDN controller. “OpenFlow” is an example of an SDN protocol for the Southbound API.

### Northbound API

The Northbound API refers to the communication between applications 220 and the SDN controller 200. It has this name because it is typically drawn as running generally upwards with respect to the SDN controller in a diagrammatic representation (which may or may not be entirely different to a physical arrangement or layout).

### Network Virtualisation and Network Functions Virtualisation

SDN can be considered as complementary to Network Virtualisation (NV) and Network Functions Virtualisation (NFV).

NV allows virtual networks to be created that are decoupled from the underlying network hardware. NFV abstracts network functions to a generic server platform rather than relying on a specific hardware device to provide the function.

SDN can provide the flexibility required for a range of NFV use cases.

### SDN Switches

There are several types of network switch available to purchase in today's market. These include so-called open switches which are switches in which the hardware and software are separate entities that can be changed independently of each other (in contrast to proprietary switches in which the software and hardware are integrated.)

So-called bare metal switches are hardware only and ready to be loaded with the operating system of the user's choice. A bare metal switch often comes with a boot loader called the Open Network Install Environment (ONIE), which allows the user to load an operating system onto the switch.

So-called white box switches and Brite box switches are bare metal switches but with an example operating system already installed. The latter type may carry a manufacturer's logo or brand name.

These various switches my generally be considered under the term “commercial off-the-shelf (“COTS”) switches”.

### Video Switching

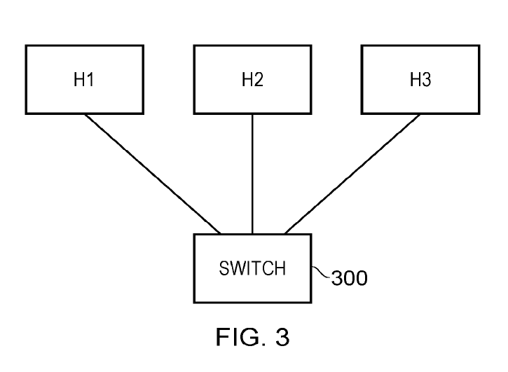

FIG. 3 is a schematic representation of three data handling devices or “hosts” H1 . . . H3, interconnected by a switch or router 300 of the type discussed with reference to FIG. 2. For example, the host devices H1, H2 may be video source devices (such as video cameras or video reproduction devices, or at least network interfaces connected or connectable to cameras or video reproduction devices) and the host device H3 may be a video sink device such as a display or video storage device, or at least a network interface connected or connectable to a display or video storage device.

Video switching can place potentially high demand on the switch infrastructure, both in terms of data throughput and also timing constraints so as to provide neat (jitter or interruption-free) transitions between different video sources. In the context of video switching, the benefit of an SDN-based approach is that it allows controller software to be written that can be used to control relatively low-cost COTS switches so as to meet such constraints.

Clean video switching requires accurately timing a particular switching operation (or in other words, a change in the data plane forwarding behaviour) so that it occurs during the vertical blanking period of the video signal(s), and/or by a method to be described below.

Clean switching from one video signal to another with a non-SDN switch of the type shown in FIG. 1 typically means using destination-timed switching, for example in which the “new” signal is joined so that both source video signals are received simultaneously for an overlap period and then the “original” signal is dropped. This can involve several delays and the requirement for double-buffering on the destination device. It can also require double the bandwidth (compared to delivery of a single video signal) to the destination device, at least during an overlap period. Some of these disadvantages can be overcome by using SDN-based switching.

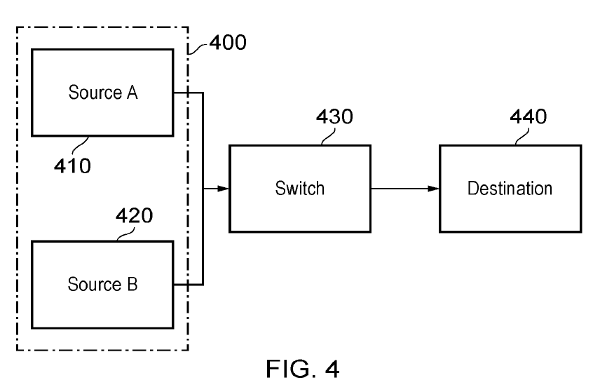

FIG. 4 schematically illustrates switching between two video sources 400, Source A 410 and Source B 420 using an SDN switch 430 so as to deliver a selected one of the two sources to a destination or sink device 440. Various possibilities will be discussed below, namely destination-timed switching, source-timed switching and switch-timed switching.

In destination-timed switching, the destination may follow the general process of:
receiving just from source A
receiving from A and B (so called double buffering, using (temporarily) double the communication bandwidth
switching from A to B at a switching point
receiving just from source B

In source-timed switching, the sources change their packet header values to trigger a new flow on the switch 430.

In switch-timed switching, the switch 430 changes its flows at a precise time.

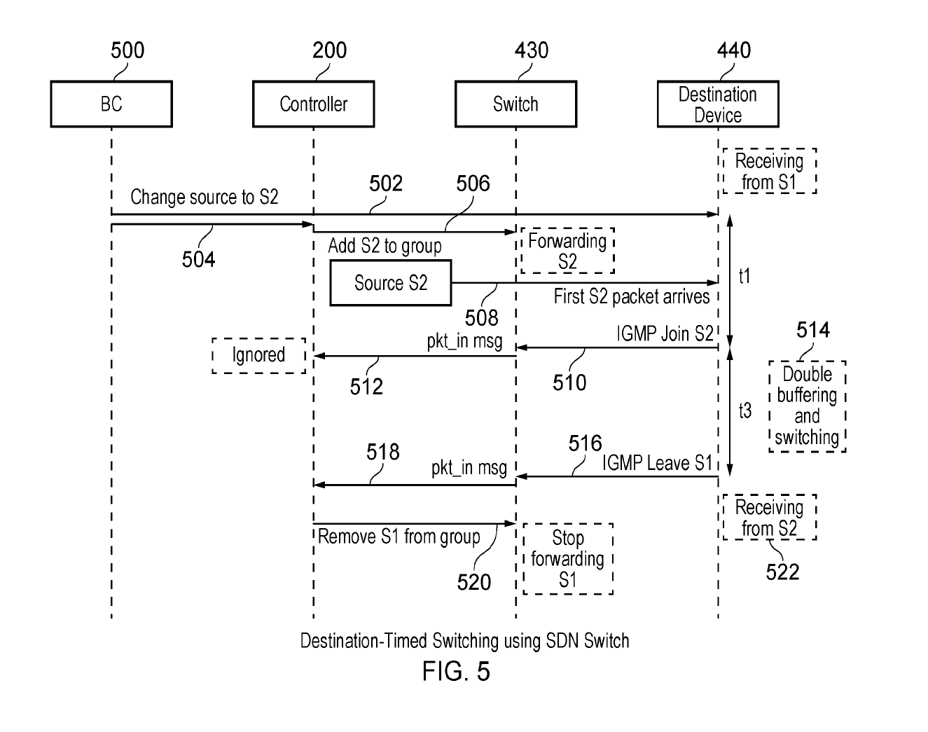

These options will be discussed with reference to FIGS. 5 to 7, each of which illustrates in a schematic timing diagram (time running vertically down the page) the interactions between a broadcast controller (“BC”) 500, the controller 200, the switch 430 and the destination device 440. Amongst the two sources 400, these are referred to as Source S1 (being the “original” one of the sources A and B which is providing video to the destination at the start of the process), and the Source S2 which is the “new” source which the destination device is switched to, so that by the end of the switching process video is being provided from the Source S2 but not the Source S1. The Sources S1 and S2 can clearly be arbitrary (but different) ones of the Sources A and B of FIG. 4.

Destination-Timed Switching using SDN Switch (FIG. 5)

Using an SDN switch can reduce the latency of destination-timed switching (compared to using a non-SDN switch). The switch can begin forwarding packets from the second source in advance of the destination device's request, removing some of the delay.

Referring to FIG. 5, a first stage 502 is that the BC 500 sends a message to the destination device 440 instructing a change of source to the source S2. Note that until that point, the destination device 440 had been receiving video signals from the source S1. The BC 500 requests the controller 200 by a request 504, which in turn requests the switch 430 by a request 506 to start forwarding video data from the source S2 and, in due course, a first packet arrives at the destination device from the source S2 at a stage 508. The destination device, a time t1 after the request 502, issues an IGMP join request to the switch 430 to join S2 at a stage 510. The switch 430 may still send a legacy IGMP join message 512 to the controller 200 but this may be ignored (at least in part because it is not necessary; the request 506 has already caused the correct routing to be applied in advance, which is how the timing advantages are provided. The IGMP message may still be used, but as a backup).

A period of double buffering and switching, during a period t3 occurs 514, at the end of which the destination device issues an IGMP leave instruction to leave the group relating to S1 at a stage 516. The switch 430 sends a packet 518 to the controller 200 which then issues a request 520 to the switch to remove S1 from the group and the switch stops forwarding packets from S1. The destination device 440 is now receiving only from S2 522.

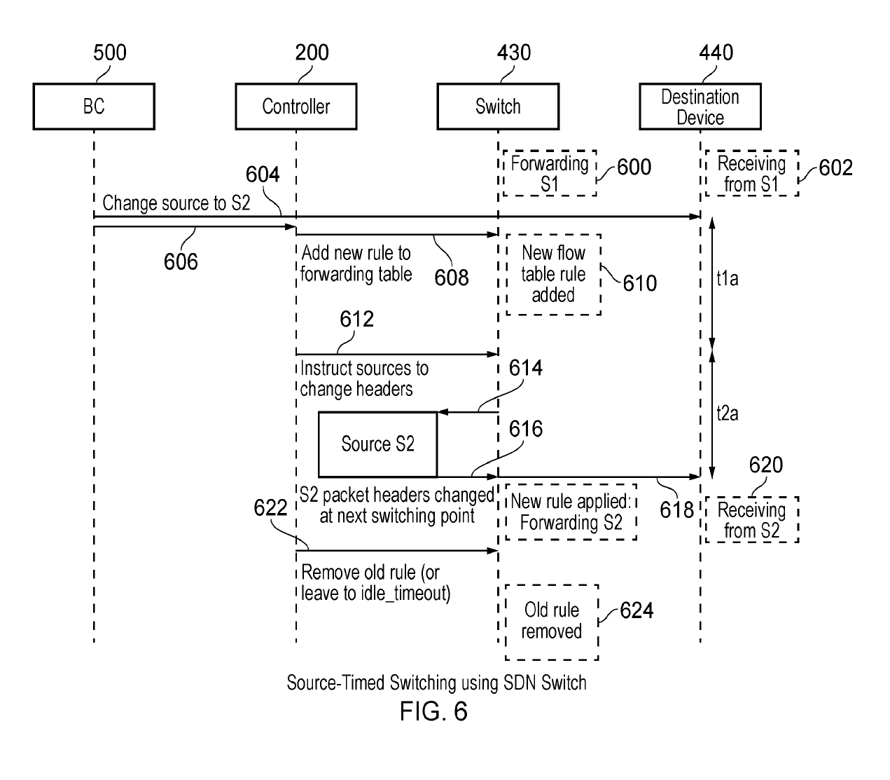

Source-Timed Switching using SDN Switch (FIG. 6)

Source-timed switching involves adding new flow rules to the switch that depend on some header information in the source packets. The sources can then change this header information at a precise time to carry out an accurately-timed switching operation.

Referring to FIG. 6, initially the switch 430 is forwarding packets from S1 600 and the destination device 440 is receiving from S1 602.

The BC 500 issues a request to the destination device 440 to change 604 the source to S2. The BC 500 also issues a request 606 to the controller which in turn instructs the switch 608 to add a new rule to the switch's forwarding table. The new rule is added at a stage 610.

The controller 200 instructs 612 the sources to change headers, which results in the switch 430 issuing an instruction or request 614 to the sources so that the packet headers are changed at the next switching point 616 and a new rule is applied by the switch 430 (at a stage 618 to forward packets from S2 so that the destination device 440 is receiving 620 from S2).

Note that the request 614 could be considered to be the ‘same’ message as 612, travelling via the switch. in other words, the message 612 could be an OpenFlow Packet Out command, causing the message 614 to be emitted. However, it can be useful to view the arrangement conceptually as the controller sending the message to Source S2 via the switch.

Note also that the command or message 612/614 could alternatively come from the BC at any time after the new forwarding rule has been applied.

The new rule is already applied (at the stage 608). The stage 618 is the stage when the rule starts matching the packets, because the packet headers change due to the instructions 612 and 614.

As a worked schematic example, assume initially that the source S2 is sending UDP packets with a destination address dst_addr=232.0.0.1 and a source port src_port=5000, and the destination device is on Port 1 of the Switch. The stage 608 sets a rule on the switch “Match src_addr=232.0.0.1, src_port=5001: Action=Output Port 1”. At this time the source S2 is sending with src_port=5000, so the rule does not currently match any packets, and S2's packets continue to be dropped. The instructions at 612/614 instruct the source S2 to start outputting with src_port=5001 (instead of 5000) at the next switching point. At the stage 616, the source S2 switches from src_port=5000 to 5001. The packets now match the rule 608, and start to be emitted from Port 1 to the Destination Device. At the stage 622, whatever rule was originally causing packets from Source 1 to Port 1 is removed (or timed out), so that by a stage 624 the old rule is no longer present.

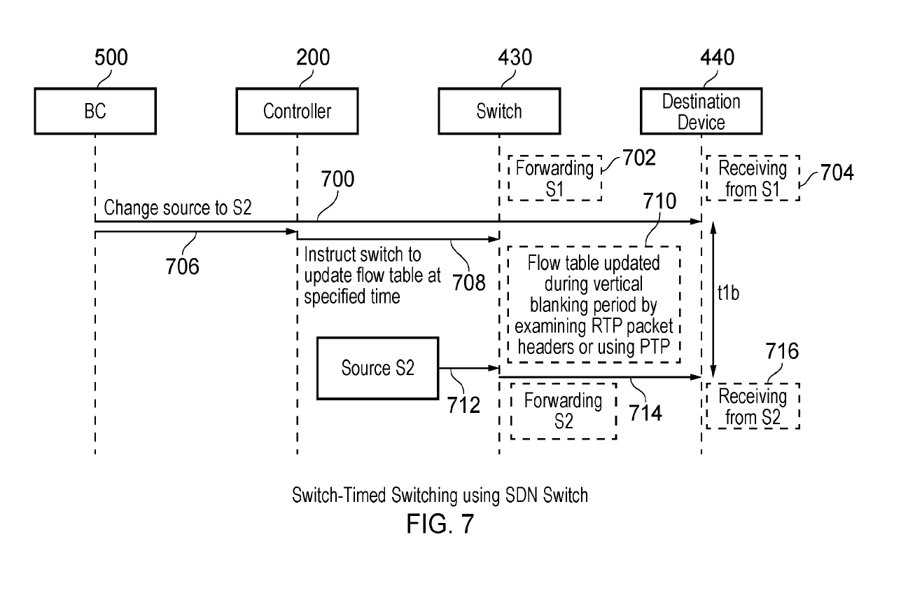

Switch-Timed Switching using SDN Switch (FIG. 7)

Switch-timed switching involves instructing the switch to update its flow table at a precise time. The switch identifies the appropriate time to update its table either by examining the RTP headers of the packets for end-of-frame information or by being compatible with the Precision Time Protocol (PTP). This method relies on the switch being able to perform the flow table update very quickly and if the packets arrive equally spaced in time this leaves a relatively small time window to achieve this. However, in example arrangements so-called “packet-shaping” may be used so that there is a longer gap between packets during the vertical blanking period of each video frame.

Referring to FIG. 7, once again the BC 500 issues a request 700 to the destination device to change source to S2. Before this is received, the switch 430 is forwarding packets from S1 702 and the destination device 440 is receiving packets from S1 704.

The BC 500 issues a request 706 to the controller 200 which in turn instructs the switch 708 to update the flow table at a specified time. The switch updates the flow table by an operation 710 during a vertical blanking period, which the switch 430 identified by examining RTP (real time protocol) packet headers or by using the PTP (precision time protocol).

The changes to the flow table imply that after the changes have been made, packets 712 from the source S2 are provided to the switch and are forwarded 714 to the destination device 440 so that after the update to the flow table, the destination device 440 is receiving 716 from the source S2.

Note that the packets 712 will have been being sent to the switch previously. The changes to the forwarding table 710 will cause them to be forwarded from 714. Although not shown in FIG. 7, optionally the update at 710 could simultaneously remove the rule forwarding packets from S1.

### Testing an SDN Network and SDN Controller

An SDN network is defined to a large extent by parameters and programming at the SDN controller 200. In applications such as video switching, it can be at least business-critical that the network operates as expected and as specified. For example, a failure to operate in the correct way could lead to a loss of live coverage of an important event, which could be damaging to the business of a broadcaster.

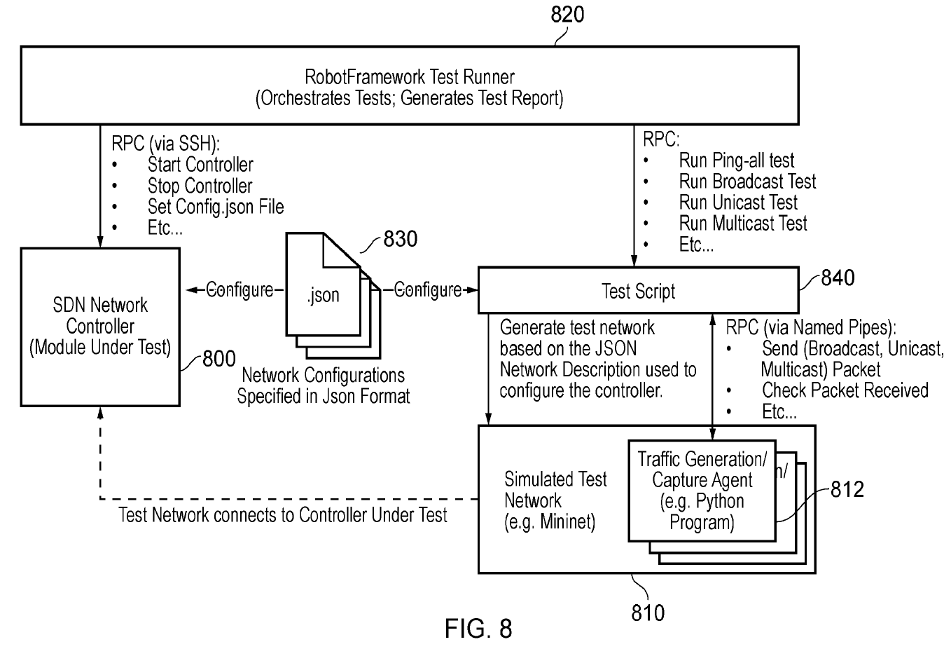

A testing arrangement, particularly suited to testing of the SDN controller 200, will now be described with reference to FIGS. 8 to 11.

FIG. 8 schematically illustrates such a testing arrangement relating to an SDN controller 800 under test. Significant components of the testing arrangement will now be described.

### (a) SDN Controller 800 Under Test

In example embodiments, the SDN controller is an OpenDaylight (ODL) based SDN controller, though other types of SDN controller may be used. The controller defines the behaviour of a Simulated Test Network 810 to be described below; the System Tests verify that this behaviour is correct. Thus the functional behaviour of the SDN controller 800 can be tested indirectly. The controller can be started, stopped and configured/re-configured by a so-called Test Runner 820 to be described below. In the example embodiments this control by the Test Runner 820 can be achieved via an SSH connection using an SSH Library of the Test Runner 820.

### (b) JSON (JavaScript Object Notation) Network Configuration File(s) 830

This configuration file, or these configuration files, are used to configure the SDN controller 800, and so provide a main subject of the test. The configuration files specify the topology of the network being managed by the controller (‘topology information’), for example defining data interconnections within the test network, as well as the locations and functions (broadcast/unicast/multicast; send/receive) of the network endpoints (‘endpoint information’). The topology information and endpoint information could be one file per configuration, or split into multiple files (such as configA.topology.json & configA.endpoints.json) respectively defining the topological relationship of nodes and the network locations and properties of endpoints as discussed above. The topology information is used to generate a simulated test network or to configure a real test network. The endpoint information is used to determine which types of traffic should be tested, and which endpoints should be involved in each test.

In some examples, JSON files representing a representative configuration may be created for each network topology that should be supported. In some examples, configurations describing real world networks which are exhibiting problems can be used to test and debug problems with actual customer deployments. As mentioned, in these example embodiments, the configuration files are in JSON format.

In other examples, a different type of document or file (or documents or files) defining the network configuration can be employed. In other words, the embodiments are not limited to the use of one or multiple JSON files.

In a general sense, these network configuration files can be static, in the sense that they are generated at the outset of network design, or at least aspects of them can be cumulative in that as a device is added to the network, a portion of a network configuration file relating to the newly added device is added to the existing file. For the purposes of the present tests, however, they are considered as static (in that a test is performed on a particular network configuration, and then if a new configuration is desired to be tested, another test may be performed). For example, there can be a set of test scenarios established for a particular configuration, which the Test Runner activates one after another. In some examples, the test runner could detect all JSON configuration files in a specified directory, and run the test suite on each of those files in turn.

Some aspects of the network configuration files can be acquired in an automated operation, for example employing “LLDP” discovery using the so-called Link Layer Discovery Protocol (LLDP) which is a protocol used by network devices for advertising their identity and/or capabilities to neighbours on a network segment.

As mentioned above, more than one file or document may be used. For example, the network definition data or file(s) may comprise, as one file or multiple respective files:

topology data defining a network topology; and

endpoint data defining network locations and functions of network endpoints.

It may be convenient to provide these as separate files or documents, of file or document fragments because (for example) one of these may be automatically obtained for example using LLDP, and the other may be statically or manually established.

In some examples, all or part of the JSON configuration might be transmitted in the body of an HTTP request or response, and such a JSON or other configuration ‘document’ would then be incorporated into a larger configuration ‘document’, which might exist tangibly on disk and/or intangibly in the memory of the SDN controller.

An example of the topology data can provide data such as:
an identifier of each network switch, and for each one:
   identifiers of ports of the switch
   identifiers of connections of those ports with ports of other switches
   data transfer properties of each port, including for example bandwidth, type of port, identifier of endpoint connected to that port

An example of the endpoint data can provide data such as:
device identifier, and for each device:
   device type (such as an audio/video device, manager device, controller device)
   network interface details such as IP address
   switch identifier
   switch port identifier
   one or more “streamer” identifiers; a device can have multiple streamers, each of which can be a sender or a receiver and can be associated with multicast, broadcast or unicast traffic types.
      In the case of a multicast traffic type, a multicast address in the multicast range 24.0.0.0 to 239.255.255.255 is provided
      multicast routing information if applicable
      streamer bandwidth information

As discussed below, the test controller circuitry 820, 840 can detect, from the endpoint data, the type of network traffic applicable to each endpoint, and can, in at least some embodiments, arrange for testing of each combination of routing for one or more of the network traffic types. By way of example, e.g. for a sender S1 and receivers R1 and R2, the multicast combinations are:

S1->{R1}

S1->{R1,R2}

S1->{R2}

The system would not however necessarily need to test both S1->{R1,R2} and S1->{R2,R1}.

Because the tests are configured using the real configuration file(s) of the SDN controller 800, the actual configuration file of a problematic deployment can be loaded directly into the test fixture and debugged as if it was a real system. This can be useful, so that users can simply provide their configuration files, and the test system can be used for triage.

Additionally, any configurations which have exposed problems or bugs (or canonical versions of those configurations) can then be added (for example permanently) to the test suite for ‘regression testing’ purposes. Regression testing is a technique to test whether computer software retains its original functionality after being subjected to changes or to interfacing with other computer software, or in other words whether previously-resolved errors or bugs resurface in later versions (or has the software “regressed” to an earlier, previously-resolved, erroneous mode of operation by subsequent modification) and is described in https://en.wikipedia.org/wiki/Regression_testing, the contents of which are incorporated by reference into the present description.

### (c) Test Runner 820

The Test Runner 820 orchestrates the system tests and generates a test report. In the example embodiments, the Test Runner 820 is implemented using the so-called RobotFramework system, which is a generic test automation framework for acceptance testing and acceptance test-driven development.

The test runner configures and starts the SDN Controller 800 under test, starts the test script which creates the test network, then triggers individual tests to be run on the network via a RPC (remote procedure call) mechanism.

The individual tests could all be run automatically by the Test Script, but running them individually from the test runner facilitates:

(a) fine grained reporting of test results, and

(b) the ability to run all tests or subsets of the test suite. (This may be important if some types of test take a long time to run.)

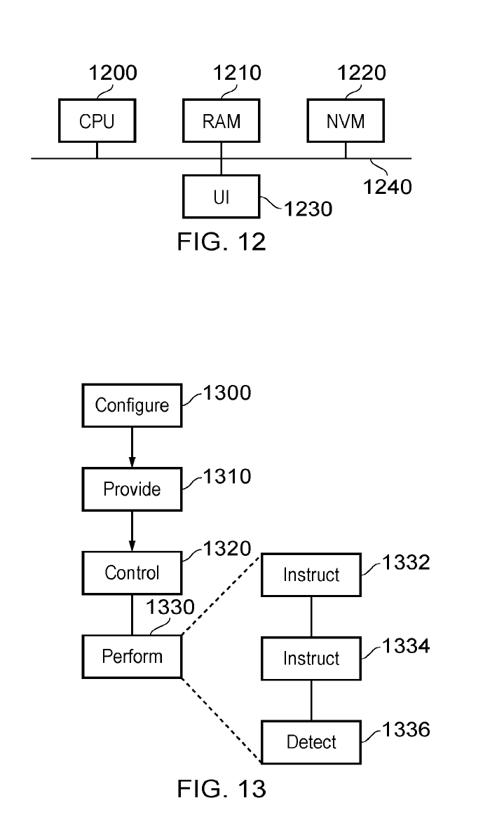

The Test Runner 820 can be implemented by appropriate program instructions executing using apparatus of the type shown in FIG. 12.

### (d) Test Script 840

The Test Script creates the Test Network and runs the individual tests.

In the example embodiments it is implemented as a Python programming language library for RobotFramework. The Test Script reads the Network Configuration File(s) to determine the topology of the test network to generate and the scope of the individual tests to perform.

The Test Script runs in the context of the Test Network where it can access the traffic generation agents running on each virtual host. Individual tests are triggered on the Test Script by the Test Runner using an RPC mechanism.

Test controller circuitry to be discussed below can be taken to encompass the functionality of the Test Runner 820 in conjunction with the test script 820.

### (e) Simulated Test Network 810

The Simulated Test Network models the network topology specified in the Network Configuration file(s), and connects to the SDN Controller 800 Under Test.

In the example embodiments, the Test Network is implemented as a simulated network using the so-called Mininet network simulator running, for example, on apparatus shown in FIG. 12, which allows for a software-parameter-configurable network emulation to be produced.

However in other embodiments it could be implemented using a real, physical network using suitable routing hardware and/or VLAN (virtual LAN) configuration. For example, switches in a hardware network under test could be linked together by software-controllable hardware switches which implement selectable connections or links between ports of the switches in the hardware network under test, so that a configurable test network is generated. At least some ports of such an arrangement could be connectable under software control to apparatus providing the functionality of the traffic generation/capture agents (to be discussed below)

### (f) Traffic Generation/Capture Agent 812

The Traffic Generation/Capture Agent 812 may be a small daemon which is run on each network endpoint in the Test Network, for example by executing appropriate program instructions on an apparatus of the type shown in FIG. 12. Each Agent, controlled via an Out-of-Band RPC mechanism, is capable of:

(i) Sending various types of network packets which are of interest (such as broadcast, unicast UDP (user datagram protocol), multicast UDP, etc.) The payloads of these packets are unique and identifiable (for example by containing so-called universally unique identifiers or UUIDs). The unique payloads are returned to the caller for future reference.

(ii) Receiving (‘sniffing’) all incoming traffic to that network endpoint, whether addressed to that endpoint or otherwise. (So called ‘promiscuous’ mode.)

(iii) Checking the sniffed packets to determine whether a packet with a given unique payload has been received or not.

Regarding the so-called Out-of-Band RPC, note that “Out-of-Band” in this context means ‘not using the test network’. In the current embodiment, the RPC is implemented using UNIX named pipes, but in other embodiments alternative channels such as secondary networks could be used. If an in-band network based RPC was used over the Test Network, it would require routing support from the SDN Controller 800 Under Test, and would create extra network traffic. This provides an example in which the test controller is configured to issue control instructions to the test traffic agents by a communication route not using the test network.

Therefore, FIG. 8 (for example when implemented by a data processing apparatus such as that of FIG. 12) provides an example of network testing apparatus comprising: software defined network controller circuitry 800; and test controller circuitry 820, 840 operable to configure a test network 810 in response to network definition data (such as the JSON file or files (or other document or documents) mentioned above) to provide instructions to control operations of the software defined network controller circuitry 800 and to control operations of a plurality of test traffic agents 812 connected to the test network 810; the software defined network controller circuitry 800 being arranged to control the test network 810 to adopt a routing arrangement for data packets within the test network in response to an instruction provided by the test controller circuitry; and the test controller circuitry 820, 840 being configured to perform a network test by instructing the software defined network controller 800 to control the test network 810 to adopt one or more test routing arrangements, instructing the test traffic agents 812 to communicate test data packets to respective destinations amongst the test traffic agents 812 using the test network 810 and detecting whether the test packets correctly arrive at their respective destinations under a current test routing arrangement as adopted by the test network 810.

As discussed, in example arrangements the test network 810 is a simulated test network configured by the test controller circuitry in response to the network definition data, the network testing apparatus comprising data processing circuitry (such as apparatus shown in FIG. 12) configured to implement, under program instruction control the simulated test network.

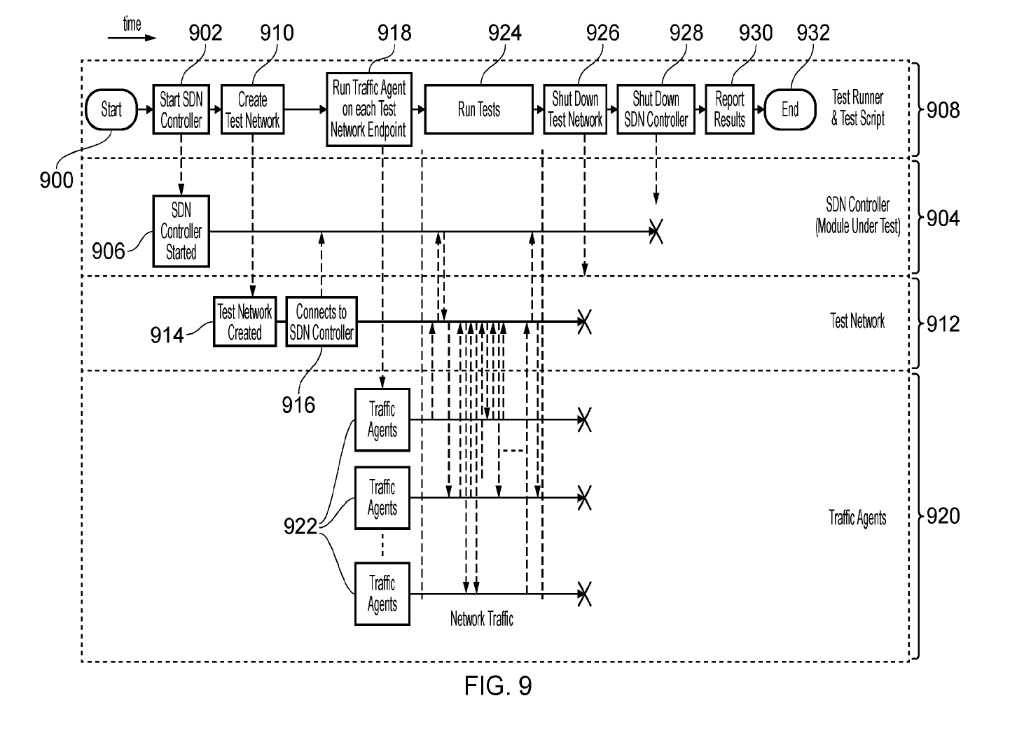

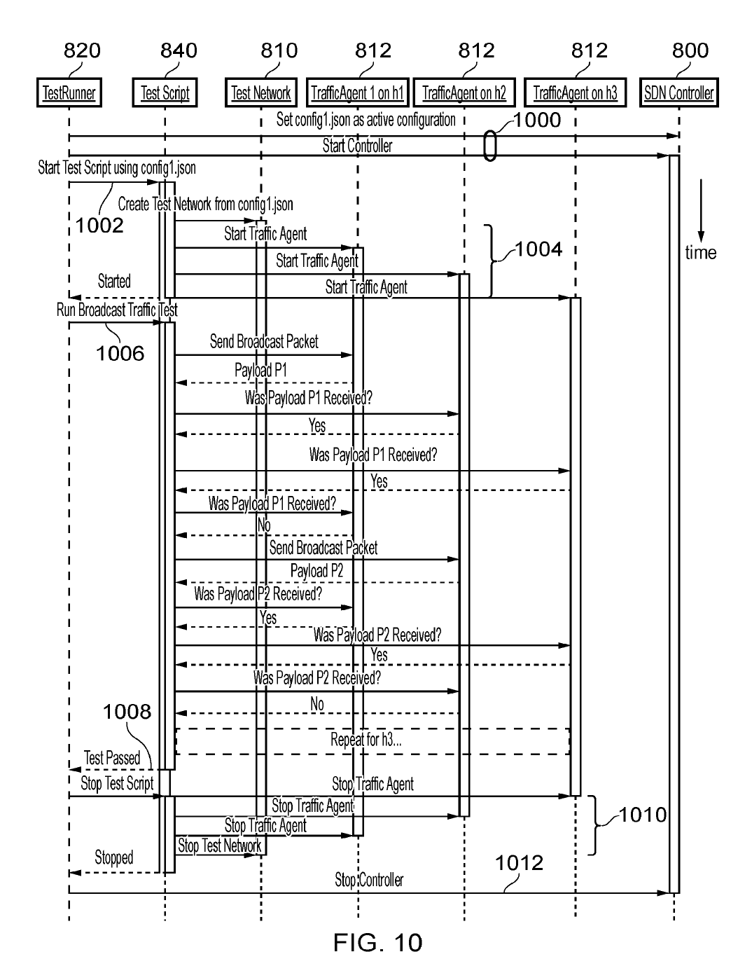

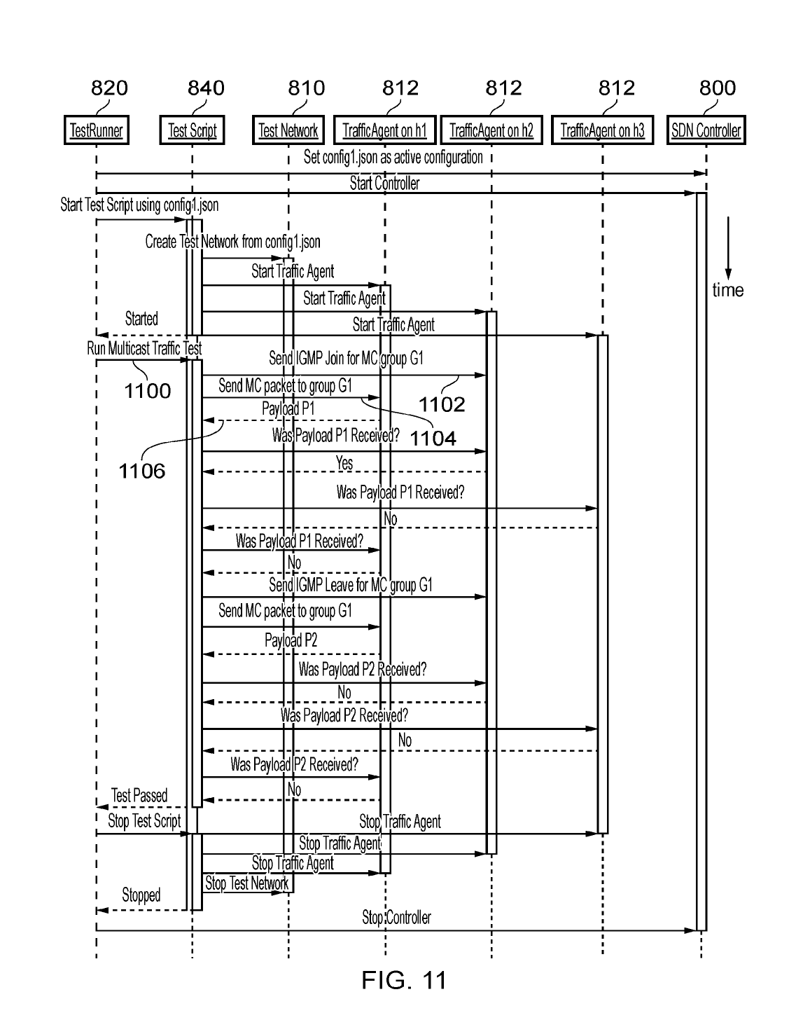

Example operations of the arrangement of FIG. 8 will now be described with reference to FIGS. 9 to 11, all of which are example schematic timing diagrams. In FIG. 9, time is represented as running from left to right across the diagram. In FIGS. 10 and 11, however, time is represented as running vertically down the diagram. In FIG. 9, there are horizontally drawn bands representing operations of the test runner and test script 908, the SDN controller 904, the test network 912 and the traffic agents 920. The test arrangements provide examples involving detecting whether the test packets correctly arrive at their respective destinations and/or detecting whether the test packets do not arrive at incorrect destinations other than their respective destinations. In examples, the test controller is configured to instruct the test traffic agents to communicate test packets by one or more of a unicast protocol, a multicast protocol and a broadcast protocol.

The operations to be discussed below can be summarized as the test controller performing a network test by:
instructing (for example, at 916 below) the software defined network controller to control the test network to adopt one or more test routing arrangements;
instructing (for example, at 922, 1006, 1100 below) the test traffic agents to communicate test data packets to respective destinations amongst the test traffic agents using the test network; and
detecting (for example at 922, 1106 below) whether the test packets correctly arrive at their respective destinations under a current test routing arrangement as adopted by the test network.

### Overall Operations (FIG. 9)

Referring to FIG. 9, after the test operations start 900, the SDN network controller under test 800 is started at a stage 902, so that in a row of FIG. 9 904 representing operations of the SDN controller, the start is noted at a stage 906.

Referring to operations of the test runner and test script 908, at a stage 910 the test runner 820 creates the test network so that in the operations of the test network 912 the creation of the network is noted at a stage 914. The test network connects to the SDN controller 800 at a stage 916.

The test runner 820 runs or establishes a traffic agent on or at each test network endpoint (as defined by the endpoint data) at a stage 918 so that in the section of FIG. 9 920 relating to the traffic agent, multiple traffic agents 922 are initiated.

The test runner 820 then runs various tests at a stage 924 in which the traffic agents are caused to interact with the SDN controller 800 under test and with one another, potentially multiple times. For example, the test runner 820 can generate instructions to the test traffic agents to communicate test data packets to respective destinations amongst the test traffic agents, in response to the functions of the network endpoints defined by the endpoint data. IN an example situation in which the endpoint data defines one or more network traffic types handled by each network endpoint, the test runner 820 can be configured to generate instructions to the test traffic agents to communicate test data packets to respective destinations amongst the test traffic agents, so as to test communication between each combination of data packet source and data packet receiver for at least a network traffic type under test. Examples of traffic types include broadcast, unicast and multicast traffic types.

Then at a stage 926 the test runner 820 shuts down the test network and at a stage 928 shuts down the SDN controller 800. The test runner reports its results at a stage 930 and the process ends 932.

### Broadcast (and Unicast) Traffic Tests (FIG. 10)

For a ‘Broadcast Traffic Test’ to be passed successfully, all endpoints regardless of function (H1, H2, H3 and so on) should be able to send broadcast packets to all other endpoints.

FIG. 10 will be described in detail below. At a summary level, the traffic agent on each host in turn is instructed to send a broadcast packet, and the payload is noted. The Test Script then checks that all other hosts received a broadcast packet with that payload. The Test Script checks that the originating host did not receive a broadcast packet with that payload.

A ‘Unicast UDP Traffic’ test would behave similarly (and so is not described here separately), except for each originating host an individual packet would be sent to each receiving host in turn, and only the specified destination host should receive that packet.

Referring to FIG. 10, the SDN controller is started at a stage 1000 and the file config1.json is set at an active configuration. This file is used at a stage 1002 to start a test script and a test network is created from the same file. Multiple traffic agents are started at a stage 1004 and a broadcast traffic test is initiated at a stage 1006 involving test packets with associated test payloads being sent to and from each of the traffic agents. Assuming at a stage 1008 that the test has been passed then the test script is stopped, the traffic agents are stopped at a stage 1010 and the controller is stopped at a stage 1012.

### Multicast Traffic Tests (FIG. 11)

For a ‘Multicast Traffic Test’, all possible packet senders should be able to send multicast traffic on the specified group(s) to all possible combinations of all packet receivers. The Senders, Multicast Groups, and Receivers are specified in the ‘endpoint information’ (in the (JSON) configuration file(s)). The Test Script analyses the endpoint information and determines which combinations of endpoints and multicast groups should be tested. The traffic agent on each combination of Receiver(s) is instructed in turn to send an IGMP Join message to subscribe to the multicast group under test. The traffic agent on each sender is instructed to send a packet with a known, unique payload to that group. The Test Script then checks that all ‘joined’ hosts received a multicast packet with that payload, and that all ‘non-joined’ hosts did not receive the packet.

The combinations of Receivers are then instructed to send IGMP Leave packets, and the same test is performed checking that all packets are now dropped. The above sequence of tests is performed for all valid combinations of Receivers, Senders and Multicast Groups.

FIG. 11 shows a similar arrangement to that of FIG. 10 and corresponding details will not be described again in detail.

At a stage 1100, a multicast traffic test is initiated which is carried out by the test script sending IGMP join instructions for multicast groups such as an example group G1, for example at a stage 1102 to various ones of the traffic agents, multicast packets are then sent with associated payloads to the group G1, for example at a step 1104 and a detection 1106 is made as to whether the correct payload was received. This process is repeated for various combinations of correspondence between the traffic agents.

### Test Selection

As discussed above, the test controller circuitry 820, 840 is configured to instruct the test traffic agents to communicate test packets by one or more n traffic types selected from the list consisting of: (i) a unicast protocol, (ii) a multicast protocol and (iii) a broadcast protocol. Given that the network definition data comprises (as discussed earlier) topology data defining a network topology; and endpoint data defining network locations and functions of network endpoints, where the endpoint data may define one or more network traffic types handled by each network endpoint, in some examples the testing regime can be established automatically in response to such network configuration data so as (for example) to test each possible routing operation available within the test network. In some embodiments, the test controller circuitry 820, 840 is configured to establish a test traffic agent 812 at each network endpoint defined by the endpoint data of the configuration data 830. In some examples, the test controller circuitry 820, 840 is configured to generate instructions to the test traffic agents 812 to communicate test data packets to respective destinations amongst the test traffic agents, in response to the functions of the network endpoints defined by the endpoint data. For example, these instructions can be provided so as to test communication between each combination of data packet source and data packet receiver for at least a network traffic type under test.

Note that the testing can encompass one or more of UDP, TCP, ICMP, ping or other types of transmission, routing and reception.

In other words, a combination of one or more of the broadcast, unicast and multicast tests discussed above can be established by the test controller circuitry 820, 840 so as to test each possible combination of one or more of:
unicast transmission from each possible unicast sender to each possible unicast receiver (as defined by the network configuration data);
broadcast transmission from each possible broadcast sender to all broadcast receivers (as defined by the network configuration data); and/or
multicast transmission from each possible multicast sender to each possible multicast group combination of receivers (as defined by the network configuration data)

One or more traffic types can be tested in this way, or all traffic types could be tested in a single testing procedure. This can involve performing multiple successive individual tests (within an overall testing process) to cover the various combinations, but can in this way provide a comprehensive testing regime for the test network.

### Data Processing Apparatus (FIG. 12)

FIG. 12 schematically illustrates a data processing apparatus comprising: one or more processing elements such as a central processing unit (CPU) 1200 to execute program instructions; a random access memory (RAM) 1210, a non-volatile memory (NVM) 1220 such as a read-only memory, a magnetic or optical disc, or a flash memory, for example to store program instructions to be loaded to RAM for execution, and a user interface (UI) 1230 to provide user control of operations and user output in response to the running of a test. These components are interconnected, for example, by a bus structure 1240. Using the apparatus of FIG. 12, the arrangement of FIG. 8 can be implemented and in particular, the method to be described with reference to FIG. 13 can be implemented by computer software which, when executed by a computer such as that of FIG. 12, causes the computer to perform such a method. A machine-readable non-transitory storage medium such as the NVM 1220 may be used to store such computer software.

FIG. 13 is a schematic flowchart illustrating a method of testing a test network having a software defined network controller to control the test network to adopt a routing arrangement, the test network having associated test traffic agents controllable by a test controller, the method comprising:

the test controller configuring (at a step 1300) the test network in response to network topology data;

the test controller providing (at a step 1310) instructions to control operations of the software defined network controller and to control operations of a plurality of test traffic agents;

the software defined network controller controlling (at a step 1320) the test network to adopt a routing arrangement for data packets within the test network in response to an instruction provided by the test controller;

the test controller performing (at a step 1330) a network test by:
instructing (at a step 1332) the software defined network controller to control the test network to adopt one or more test routing arrangements;
instructing (at a step 1334) the test traffic agents to communicate test data packets to respective destinations amongst the test traffic agents using the test network; and
detecting (at a step 1336) whether the test packets correctly arrive at their respective destinations under a current test routing arrangement as adopted by the test network.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Similarly, a data signal comprising coded data generated according to the methods discussed above (whether or not embodied on a non-transitory machine-readable medium) is also considered to represent an embodiment of the present disclosure.

It will be apparent that numerous modifications and variations of the present disclosure are possible in light of the above teachings. It is therefore to be understood that within the scope of the appended clauses, the technology may be practised otherwise than as specifically described herein.

Respective aspects and features are defined by the following numbered clauses:

1. Network testing apparatus comprising:

software defined network controller circuitry; and

test controller circuitry operable to configure a test network in response to network definition data, to provide instructions to control operations of the software defined network controller circuitry and to control operations of a plurality of test traffic agents connected to the test network;

the software defined network controller circuitry being arranged to control the test network to adopt a routing arrangement for data packets within the test network in response to an instruction provided by the test controller circuitry; and

the test controller circuitry being configured to perform a network test by instructing the software defined network controller circuitry to control the test network to adopt one or more test routing arrangements, instructing the test traffic agents to communicate test data packets to respective destinations amongst the test traffic agents using the test network and detecting whether the test packets correctly arrive at their respective destinations under a current test routing arrangement as adopted by the test network.

2. Apparatus according to clause 1, in which the test network is a simulated test network configured by the test controller circuitry in response to the network definition data, the network testing apparatus comprising data processing circuitry configured to implement, under program instruction control the simulated test network.
3. Apparatus according to clause 1 or clause 2, in which the test controller circuitry is configured to issue control instructions to the test traffic agents by a communication route not using the test network.
4. Apparatus according to any one of the preceding clauses, in which the test controller circuitry is configured to detect whether the test packets do not arrive at incorrect destinations other than their respective destinations.
5. Apparatus according to any one of the preceding clauses, in which the test controller circuitry is configured to instruct the test traffic agents to communicate test packets by one or more n traffic types selected from the list consisting of: (i) a unicast protocol, (ii) a multicast protocol and (iii) a broadcast protocol.
6. Apparatus according to any one of the preceding clauses, in which the network definition data comprises:

topology data defining a network topology; and

endpoint data defining network locations and functions of network endpoints.

7. Apparatus according to clause 6, in which the test controller circuitry is configured to establish a test traffic agent at each network endpoint defined by the endpoint data.
8. Apparatus according to clause 7, in which the test controller circuitry is configured to generate instructions to the test traffic agents to communicate test data packets to respective destinations amongst the test traffic agents, in response to the functions of the network endpoints defined by the endpoint data.
9. Apparatus according to clause 8, in which the endpoint data defines one or more network traffic types handled by each network endpoint.
10. Apparatus according to clause 9, in which the test controller circuitry is configured to generate instructions to the test traffic agents to communicate test data packets to respective destinations amongst the test traffic agents, so as to test communication between each combination of data packet source and data packet receiver for at least a network traffic type under test.
11. A method of testing a test network having a software defined network controller to control the test network to adopt a routing arrangement, the test network having associated test traffic agents controllable by a test controller, the method comprising:

the test controller configuring the test network in response to network topology data;

the test controller providing instructions to control operations of the software defined network controller and to control operations of a plurality of test traffic agents;

the software defined network controller controlling the test network to adopt a routing arrangement for data packets within the test network in response to an instruction provided by the test controller;

the test controller performing a network test by:
instructing the software defined network controller to control the test network to adopt one or more test routing arrangements;
instructing the test traffic agents to communicate test data packets to respective destinations amongst the test traffic agents using the test network; and
detecting whether the test packets correctly arrive at their respective destinations under a current test routing arrangement as adopted by the test network.
   12. Computer software which, when executed by a computer, causes the computer to perform the method of clause 11.
   13. A machine-readable non-transitory storage medium which stores computer software according to clause 12.

1. Network testing apparatus comprising:
software defined network controller circuitry; and
test controller circuitry operable to configure a test network in response to network definition data, to provide instructions to control operations of the software defined network controller circuitry and to control operations of a plurality of test traffic agents connected to the test network;
the software defined network controller circuitry being arranged to control the test network to adopt a routing arrangement for data packets within the test network in response to an instruction provided by the test controller circuitry; and
the test controller circuitry being configured to perform a network test by instructing the software defined network controller circuitry to control the test network to adopt one or more test routing arrangements, instructing the test traffic agents to communicate test data packets to respective destinations amongst the test traffic agents using the test network and detecting whether the test packets correctly arrive at their respective destinations under a current test routing arrangement as adopted by the test network.

2. Apparatus according to claim 1, in which the test network is a simulated test network configured by the test controller circuitry in response to the network definition data, the network testing apparatus comprising data processing circuitry configured to implement, under program instruction control the simulated test network.

3. Apparatus according to claim 1, in which the test controller circuitry is configured to issue control instructions to the test traffic agents by a communication route not using the test network.

4. Apparatus according to claim 1, in which the test controller circuitry is configured to detect whether the test packets do not arrive at incorrect destinations other than their respective destinations.

5. Apparatus according to claim 1, in which the test controller circuitry is configured to instruct the test traffic agents to communicate test packets by one or more n traffic types selected from the list consisting of: (i) a unicast protocol, (ii) a multicast protocol and (iii) a broadcast protocol.

6. Apparatus according to claim 1, in which the network definition data comprises:
topology data defining a network topology; and
endpoint data defining network locations and functions of network endpoints.

7. Apparatus according to claim 6, in which the test controller circuitry is configured to establish a test traffic agent at each network endpoint defined by the endpoint data.

8. Apparatus according to claim 7, in which the test controller circuitry is configured to generate instructions to the test traffic agents to communicate test data packets to respective destinations amongst the test traffic agents, in response to the functions of the network endpoints defined by the endpoint data.

9. Apparatus according to claim 8, in which the endpoint data defines one or more network traffic types handled by each network endpoint.

10. Apparatus according to claim 9, in which the test controller circuitry is configured to generate instructions to the test traffic agents to communicate test data packets to respective destinations amongst the test traffic agents, so as to test communication between each combination of data packet source and data packet receiver for at least a network traffic type under test.

11. A method of testing a test network having a software defined network controller to control the test network to adopt a routing arrangement, the test network having associated test traffic agents controllable by a test controller, the method comprising:
the test controller configuring the test network in response to network topology data;
the test controller providing instructions to control operations of the software defined network controller and to control operations of a plurality of test traffic agents;
the software defined network controller controlling the test network to adopt a routing arrangement for data packets within the test network in response to an instruction provided by the test controller;
the test controller performing a network test by:
instructing the software defined network controller to control the test network to adopt one or more test routing arrangements;
instructing the test traffic agents to communicate test data packets to respective destinations amongst the test traffic agents using the test network; and
detecting whether the test packets correctly arrive at their respective destinations under a current test routing arrangement as adopted by the test network.

12. Computer software which, when executed by a computer, causes the computer to perform the method of claim 11.

13. A machine-readable non-transitory storage medium which stores computer software according to claim 12.
